(19) United States
(12) Patent Application Publication
(10) Pub. No.: US 2018/0174062 A1
(43) Pub. Date: Jun. 21, 2018

(54) ROOT CAUSE ANALYSIS FOR SEQUENCES OF DATACENTER STATES

(71) Applicant: CA, INC., New York, NY (US)

(72) Inventors: MARC SOLE SIMO, BARCELONA (ES); JAUME FERRARONS LLAGOSTERA, BARCELONA (ES); DAVID SANCHEZ CHARLES, BARCELONA (ES); DAVID SOLANS NOGUERO, BARCELONA (ES); ALBERTO HUELAMO SEGURA, BARCELONA (ES); VICTOR MUNTES MULERO, BARCELONA (ES)

(21) Appl. No.: 15/392,515

(22) Filed: Dec. 28, 2016

(30) Foreign Application Priority Data
Dec. 21, 2016 (ES) P 201631646

(51) Int. Cl. G06N 5/04; G06N 3/04; G06N 3/08

(52) U.S. Cl. CPC G06N 5/047; G06N 3/08; G06N 3/04

(57) ABSTRACT

In a datacenter setting, root causes of anomalies corresponding to components in the datacenter are predicted. Initially, a convolutional neural network (CNN) is utilized to consider the evolution sequence of the datacenter infrastructure. Given a set of training data (sequences of datacenter states that are labeled with root causes of the anomalies present in the sequences), the CNN learns which sequences of datacenter states correspond to the labels of root causes. Accordingly, given a set of input or test data (sequences of datacenter states that are not labeled with root causes of the anomalies present in the sequences), the CNN is able to predict a root cause for the anomaly even in a previously unseen or different datacenter infrastructure.

### RELATED APPLICATION

This application claims priority to Spanish Application No. P 201631646, filed Dec. 21, 2016.

### BACKGROUND

Organizations often struggle to understand which components are the root cause for a particular anomaly that has been detected in a datacenter setting. Even more challenging to the organization is identifying root causes before the anomaly leads to additional anomalies or causes components to fail. Automated root cause analysis in datacenters may help reduce the mean time to resolve anomalies and reduce operating expense. Current automated root cause analysis methods can be divided in two big families: model-based and classifiers (in the machine learning context). Broadly speaking, current model-based methods require models that are expensive to generate (e.g., manual rules in a rule-based system). Moreover, current classifiers require training data. As a result, both methods perform poorly if components in the datacenter change, as is typical in most datacenter settings. For example, components are commonly added or removed and relationships between components may be modified. Additionally, the current methods are unable to account for different or unknown environments, such as when using a model-based method or a classifier developed for a particular datacenter on another datacenter. Further, neither method considers evolving states of a datacenter and instead only consider a single point in time.

### SUMMARY

This summary is provided to introduce a selection of concepts in a simplified form that are further described below in the detailed description. This summary is not intended to identify key features or essential features of the claimed subject matter, nor should it be used as an aid in determining the scope of the claimed subject matter.

Embodiments of the present disclosure relate to predicting root causes of anomalies in a datacenter. To do so, a convolutional neural network (CNN) is utilized to consider the evolution sequence of the datacenter infrastructure. Given a set of training data (sequences of datacenter states that are labeled with root causes of the anomalies present in the sequences), the CNN learns which sequences of datacenter states correspond to the labels of root causes. Accordingly, given a set of input or test data (sequences of datacenter states that are not labeled with root causes of the anomalies present in the sequences), the CNN is able to predict a root cause for the anomaly even in a previously unseen or different datacenter infrastructure.

### BRIEF DESCRIPTION OF THE DRAWINGS

The present invention is described in detail below with reference to the attached drawing figures, wherein:

FIG. 1 is a block diagram showing a root cause analysis system that provides root causes of anomalies in a datacenter, in accordance with an embodiment of the present disclosure;

FIG. 2 is an exemplary hash algorithm for context graph nodes using a single property, in accordance with an embodiment of the present disclosure;

FIG. 3 is an exemplary hash algorithm for context graph nodes using multiple properties, in accordance with embodiments of the present disclosure;

FIG. 4 is a flow diagram showing a method of training a classifier with a root cause corresponding to a sequence of historical datacenter states, in accordance with embodiments of the present disclosure;

FIG. 5 is a flow diagram showing a method of utilizing a classifier to label an anomalous condition detected in a datacenter at a particular state, in accordance with embodiments of the present disclosure; and

FIG. 6 is a block diagram of an exemplary computing environment suitable for use in implementing embodiments of the present disclosure.

### DETAILED DESCRIPTION

The subject matter of the present disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. For example, although this disclosure refers to generating context graphs that represent datacenters in illustrative examples, aspects of this disclosure can be applied to generating context graphs that represent relationships between components in a local hardware or software system, such as a storage system or distributed software application. Moreover, although the terms “step” and/or “block” may be used herein to connote different elements of methods employed, the terms should not be interpreted as implying any particular order among or between various steps herein disclosed unless and except when the order of individual steps is explicitly described. As used herein, the singular forms “a,” “an,” and “the” are intended to include the plural forms as well, unless the context clearly indicates otherwise.

The term “component” as used in the description below encompasses both hardware and software resources. The term component may refer to a physical device such as a computer, server, router, etc., a virtualized device such as a virtual machine or virtualized network function, or software such as an application, a process of an application, database management system, etc. A component may include other components. For example, a server component may include a web service component which includes a web application component.

The term “context graph” or “graph embedding” refers to a data structure that depicts connections or relationships between components. A context graph consists of nodes (vertices, points) and edges (arcs, lines) that connect them. A node represents a component, and an edge represents a relationship between the corresponding components. Nodes and edges may be labeled or enriched with data or properties. For example, a node may include an identifier for a component, and an edge may be labeled to represent different types of relationships, such as a hierarchical relationship or a cause-and-effect type relationship. In embodiments where nodes and edges are enriched with data, nodes and edges may be indicated with data structures that allow for the additional information, such as JavaScript Object Notation (“JSON”) objects, extensible markup language (“XML”) files, etc. Context graphs may also be referred to in related literature as a triage map, relationship diagram/chart, causality graph, etc.

The term “subgraph” refers to a portion of a context graph. Subgraphs may be stored in a historical database as training data and may be aggregated to facilitate data imputation for missing data in a context graph. Subgraphs may additionally be utilized to diagnose particular problems in a datacenter. For example, if a particular problem occurs, the subgraphs that generate a particular hash for the particular problem may be provided to help identify a source of the problem in the datacenter.

Properties of a subgraph or context graph may be described by a “hash” or a “vector representation”. A hash may be determined based on a particular property or properties of a node. The properties may be metrics of the node or aggregated neighbor related information. The aggregated neighbor related information may include a number of neighbors of the node, an absolute number of neighbors with some condition, a relative number of neighbors with some condition, a sum/maximum/minimum/average of some node properties, etc. For clarity, a “neighbor” corresponds to a node that is directly connected to the subject node by an edge. The edge may correspond to relationships among hardware and software components between the nodes.

The hash may be additionally computed through a predetermined number of iterations which may be based on a diameter of the subgraph or context graph, desired input size, etc. For example, at iteration 0, the hash includes a hash of the particular node. At iteration 1, the hash includes a hash of the hash of the particular node and the hash of neighbor nodes. At iteration 2, the hash includes a hash of the hash of the particular node, the hash of the neighbor nodes, and the hash of the neighbors of the neighbor nodes. In this way the hash provides a fingerprint or identifying characteristics of the subgraph or context graph corresponding to properties of nodes of the subgraph or context graph that can be utilized to identify similar subgraphs or context graphs.

A vector representation may correspond to the hash itself, or a string of hashes being considered (e.g., hashes of multiple properties or for multiple nodes). In embodiments, a vector representation corresponds to a subgraph or context graph as it evolves over time. For example, as a particular property or node changes over time, the vector representation represents the hash of the particular node as it changes over time which may help diagnose a particular a root cause of an anomalous condition, predict a future state of the datacenter (e.g., a particular property or particular node), identify missing properties, summarize a state of the datacenter, compare states of the datacenter, and the like.

The description below refers to an “anomalous condition” to describe a message or notification of an unexpected occurrence in a system or in a component of the system at a point in time. An anomalous condition often relates to resource consumption and/or state of a system or system component. As examples, an anomalous condition may be that a file was added to a file system, that a number of users of an application exceeds a threshold number of users, that an amount of available memory falls below a memory amount threshold, or that a component stopped responding or failed. An anomalous condition can reference or include data or properties about the anomalous condition and is communicated to by an agent or probe to a component/agent/process that processes anomalous conditions. The data or properties about the anomalous condition may be utilized to build a context graph or a subgraph.

As noted in the background, organizations often struggle to understand which components are the root cause for a particular anomaly that has been detected in a datacenter setting. Even more challenging to the organization is identifying root causes before the anomaly leads to additional anomalies or causes components to fail. Automated root cause analysis in datacenters may help reduce the mean time to resolve anomalies and reduce operating expense. Automated root cause analysis methods can be divided in two big families: model-based and classifiers (in the machine learning context). Broadly speaking, model-based methods require models that are expensive to generate (e.g., manual rules in a rule-based system) and classifiers require training data. As a result, both methods perform poorly if components in the datacenter change, as is typical in most datacenter settings. For example, components are commonly added or removed and relationships between components may be modified. Additionally, each method is unable to account for different or unknown environments, such as when using a model-based method or a classifier developed for a particular datacenter on another datacenter. Further, neither method considers evolving states of a datacenter and instead only consider a single point in time.

Embodiments of the present disclosure are generally directed to predicting root causes of anomalies in a datacenter. To do so, a convolutional neural network (CNN) is utilized to consider the evolution sequence of the datacenter infrastructure. Although described below with reference to a CNN, it is contemplated that other types of neural networks (e.g., recurrent neural networks) may be utilized and/or be combined with the CNN within the scope of the present disclosure. Given a set of training data (sequences of datacenter states that are labeled with root causes of the anomalies present in the sequences), the CNN learns which sequences of datacenter states correspond to the labels of root causes. Accordingly, given a set of input or test data (sequences of datacenter states that are not labeled with root causes of the anomalies present in the sequences), the CNN is able to predict a root cause for the anomaly even in a previously unseen or different datacenter infrastructure.

In practice, a monitoring tool receives data from the different components of the datacenter. Upon detecting an anomaly, such as by an anomaly detector, the data is provided to a root cause analysis system that is connected to the anomaly detector. Data is normally processed in the monitoring tool; however, periodically, historical data is provided to the root cause analysis system as training data. This data contains the anomalies and metrics of components of the datacenter along with a label identifying the root cause of the anomalies. In embodiments, labels include false positives, artifacts, and incidental so that normal operations, despite having anomalies, can also be considered.

Using the historical data, a CNN (the classifier) is trained with some iterative training method, for example, batch or stochastic gradient descent. To obtain a classifier that is reusable as much as possible across different datacenters (so that a classifier trained in a particular datacenter can be leveraged across multiple datacenters), the input neurons of the data, as explained in more detail below, contain a sequence of a configurable number of states. In this way, evolution of the datacenter can be a factor in both training and testing for the CNN. In some embodiments, a software as a service (SaaS) enables sharing of historical data or anonymized information pertaining to the structure of the CNN itself.

In some embodiments, it is possible to obtain which types of configurations are associated to a particular label, thus creating “graph stereotypes” associated to particular problems. This information is valuable to provide human-understandable diagnosis explanations and can be used to feed a rule-based or graph-rule-based diagnostic system (i.e., a system that works with rules, but in which rules are specified using graph properties, such as reachability, centrality, etc.).

The data may be received in the form of a subgraph or context graph. The subgraph or context graph comprises nodes corresponding to components of the datacenter and edges corresponding to relationships between the nodes. A given node that is connected by an edge to another node is a neighbor of that node. Each node may include data or properties (e.g., metrics, anomalies, root causes) that can be encoded using hashing techniques (e.g., a circular hashing process). The hash may additionally have a predetermined number of iterations which may be based on a diameter of the subgraph or context graph, desired input size, etc. A vector representation may correspond to the hash itself, or a string of hashes being considered (e.g., hashes of multiple properties or for multiple nodes).

In embodiments, each state of a given node represents not just a set of anomalies or metrics, but includes anomalies or metrics of its neighbors. This enables relationships between nodes to be considered by the classifier, which may be essential in identifying the root cause for a particular anomaly. Alternatively, encodings such as assuming a model in which at most k neighbors per node are considered (which may require a selection of the most important k neighbors if the node has more than k neighbors or dummy neutral input values when the node has less than k neighbors). Additional metrics that can be considered by the classifier and scale regardless of the how many neighbors a node has may include number of neighbors, percentage of neighbors with a particular condition, average of some continuous metrics of the neighbors (useful for instance to model demand on a database node if we consider the number of SQL queries as the continuous metric).

Accordingly, one embodiment of the present disclosure is directed to a method that facilitates training a classifier to predict a root cause of an anomaly detected in a datacenter. The method comprises receiving a historical context graph indicating a plurality of relationships among a plurality of historical nodes corresponding to components of a historical datacenter. Each historical node comprises historical properties corresponding to a particular historical component of the historical datacenter. The method also comprises, for each historical node in the historical context graph, determining a sequence of historical datacenter states represented by a plurality of historical hashes based on selected historical properties of the historical node and the selected historical properties of neighbors of the historical node. The method further comprises training a classifier with root causes corresponding to the sequence of historical datacenter states.

In another embodiment, the present disclosure is a method that facilitates labeling a root cause for an anomalous condition detected in a datacenter. The method includes, based on an anomalous condition detected in a datacenter at a particular state, receiving a context graph indicating a plurality of relationships among a plurality of nodes corresponding to components of the datacenter. Each node comprises properties corresponding to a particular component. The method also comprises, for each node in the context graph, determining a plurality of hashes based on selected properties of the node and the selected properties of neighbors of the node. The method further comprises providing the plurality of hashes to a classifier. The method also comprises, utilizing the classifier, labeling a root cause for the anomalous condition detected in the datacenter at the particular state.

In yet another embodiment, the present disclosure is directed to a computerized system that utilizes a classifier to label a root cause for an anomalous condition detected in a datacenter. The system includes a processor and a non-transitory computer storage medium storing computer-useable instructions that, when used by the processor, cause the processor to receive a historical context graph indicating a plurality of relationships among a plurality of historical nodes corresponding to components of a historical datacenter. Each historical node comprises historical properties corresponding to a particular historical component. For each historical node in the historical context graph, a sequence of datacenter states is determined that is represented by a plurality of historical hashes based on selected historical properties of the historical node and the selected historical properties of neighbors of the historical node. A classifier is trained with root causes corresponding to the sequence of datacenter states. Utilizing the classifier, a root cause is labeled for a particular anomalous condition detected in a datacenter at a particular state.

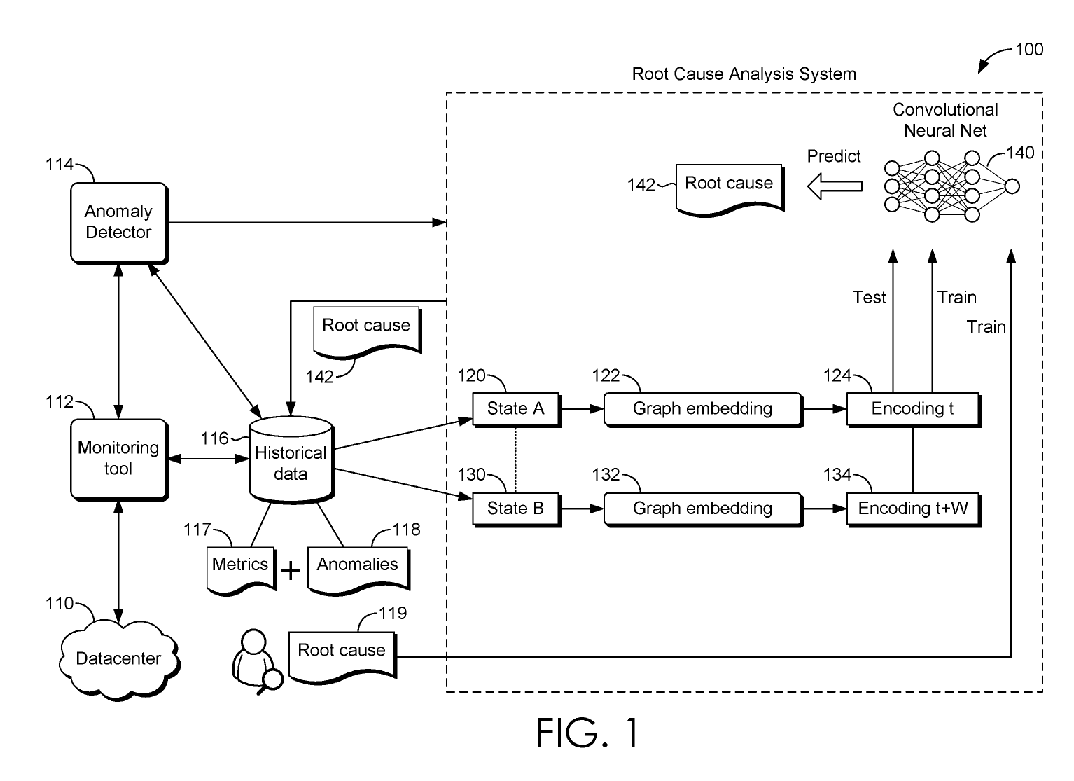

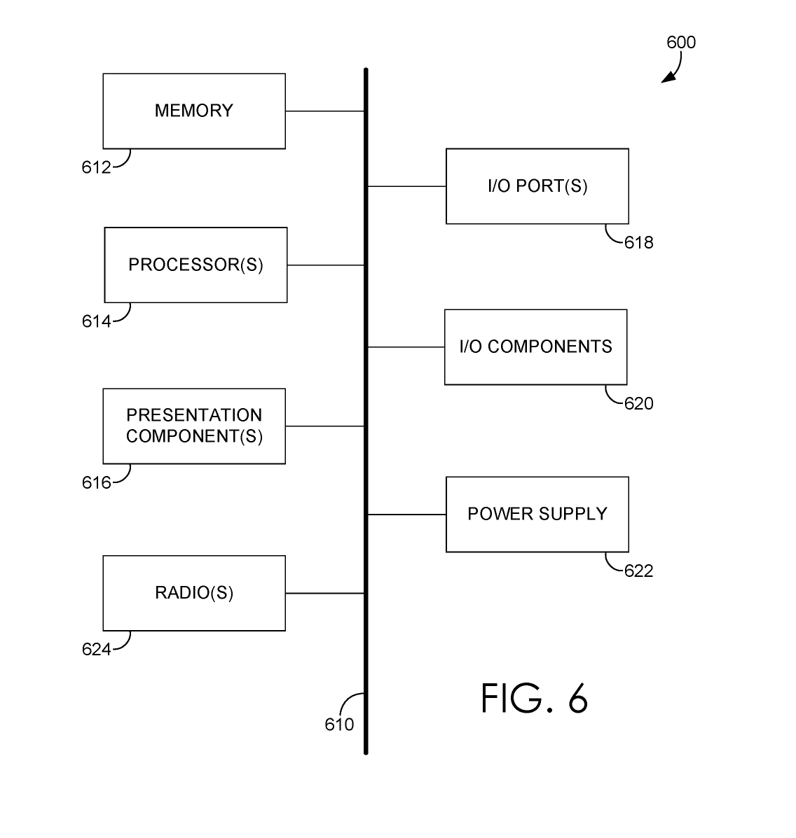

Referring now to FIG. 1, a block diagram is provided that illustrates a root cause analysis system 100 that provides root causes of anomalies in a datacenter, in accordance with an embodiment of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory. The root cause analysis system 100 may be implemented via any type of computing device, such as computing device 600 described below with reference to FIG. 6, for example. In various embodiments, the root cause analysis system 100 may be implemented via a single device or multiple devices cooperating in a distributed environment.

The root cause analysis system 100 generally operates to provide a root cause for an anomaly that has been detected in a datacenter. As shown in FIG. 1, the root cause analysis system 100 communicates with, among other components not shown, datacenter 110, monitoring tool 112, anomaly detector 114, and database 116. It should be understood that the root cause analysis system 100 shown in FIG. 1 is an example of one suitable computing system architecture. Each of the components shown in FIG. 1 may be implemented via any type of computing device, such as computing device 600 described with reference to FIG. 6, for example.

The components may communicate with each other via a network, which may include, without limitation, one or more local area networks (LANs) and/or wide area networks (WANs). Such networking environments are commonplace in offices, enterprise-wide computer networks, intranets, and the Internet. It should be understood that any number of datacenters, monitoring tools, anomaly detectors, or historical databases may be employed by the root cause analysis system 100 within the scope of the present disclosure. Each may comprise a single device or multiple devices cooperating in a distributed environment. For instance, the root cause analysis system 100 may be provided via multiple devices arranged in a distributed environment that collectively provide the functionality described herein. In some embodiments, some or all functionality provided by monitoring tool 112, anomaly detector 114, and/or database 116 may be provided by root cause analysis system 100. Additionally, other components not shown may also be included within the network environment.

As shown in FIG. 1, the root cause analysis system 100 communicates with a database 116. While only a single database 116 is shown in FIG. 1, it should be understood that the root cause analysis system 100 may communicate with any number of databases. Each datacenter 110 may utilize multiple databases corresponding to different entities, affiliates, business units, systems, etc., of the organization. Each database 116 may store metrics 117 of various components in the datacenter that are received from monitoring tool 112. Each database 116 may additionally store anomalies 119 detected by anomaly detector 114. Additionally, database 116 may include a root cause 119, 142 for one or more of the anomalies 119. In various embodiments, the root cause is manually provided by a user (e.g., root cause 119), automatically provided by the root cause analysis system 100 (e.g., root cause 142), or a combination thereof. If the root cause has been automatically provided by the root cause analysis system 100, it may be labeled as such so it can later be validated (e.g., accepted or changed) by a human. Once validated, the root cause may be utilized as training data along with the manually provided root causes (e.g., root cause 119).

The root cause analysis system 100 initially receives training data from database 116. The training data comprises metrics 117 and anomalies 118. The training data additionally comprises root cause 119 that has been manually provided by a user or root cause 142 that has been automatically provided by the root cause analysis system 100 and, in some embodiments, validated by a user. Each instance of training data also corresponds to a state that may be represented by a timestamp indicating when the metrics and/or anomalies occurred within a particular component of datacenter 110. Root cause analysis system 100 receives training data for multiple states, as illustrated in FIG. 1 by state A 120 and state B 130 (also utilized to illustrate test data as described below). Receiving multiple states enables the root cause analysis system 100 to consider data as it evolves over time and more accurately predict root causes.

After receiving the training data from database 116 corresponding to multiple states, the data is utilized to build a context graph or subgraph. As described above, a context graph refers to a data structure that depicts connections or relationships between components of the datacenter. The context graph consists of nodes (vertices, points) and edges (arcs, lines) that connect them. Each node represents a component and each edge represents a relationship between the corresponding components. The nodes and edges may be labeled or enriched with the metrics, anomalies, and/or root causes. In some embodiments, the training data is received as a context graph or subgraph that has already been built prior to being received by root cause analysis system 100.

As illustrated, the training data for each state, as illustrated by state A 120 through state B 130 (also utilized to illustrate test data as described below), is embedded into a context graph or subgraph, as illustrated by graph embedding 122 through graph embedding 132. The context graphs or subgraphs are utilized to determine an encoding (as illustrated by encoding t 124 through encoding t+W 134). Although FIG. 1 depicts state A 120 and state B 130, the actual number of states utilized as training data corresponds to a time window of size W where each state corresponds to increments of time Δt up to size W. In this way, for example, the root cause analysis system is trained using encodings t, t₁, t₂, t₃, t₄, . . . t_{w}. Thus, the encoding is a sequence of datacenter states represented by a plurality of hashes. The hashes are based on selected properties of the node and selected properties of neighbors of the node. In some embodiments, padding is utilized to encode a particular property of a particular node when the node has less than K neighbors. Alternatively, if the particular node has more than K neighbors, the neighbors may be sorted by relevance for the particular property and the top K neighbors are selected.

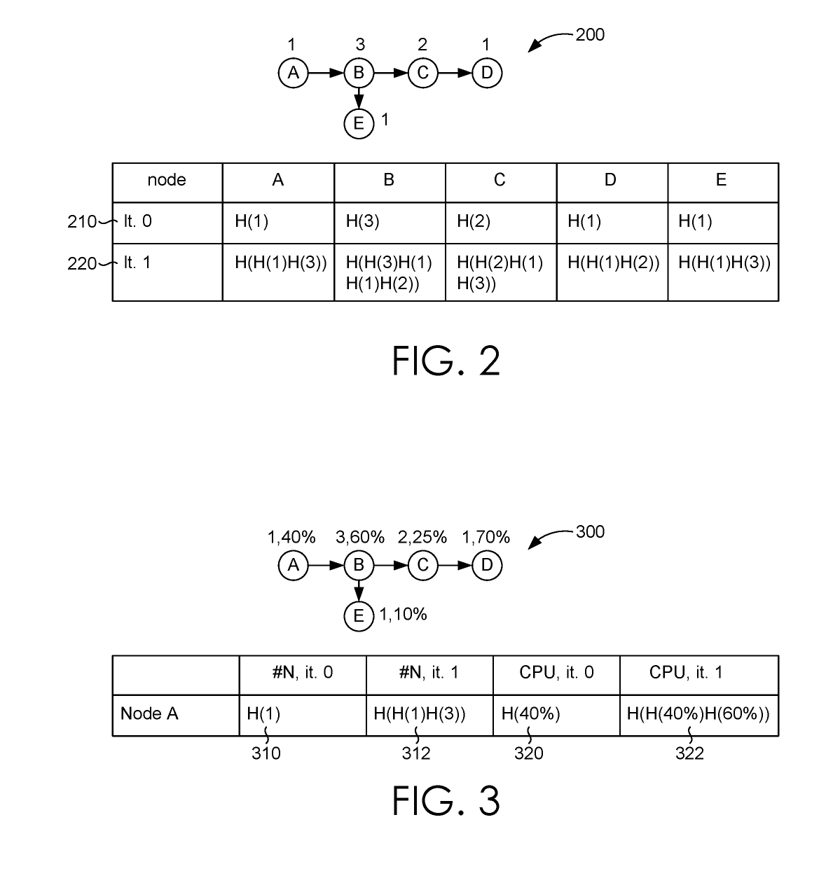

With reference to FIG. 2, an exemplary hash algorithm is illustrated for context graph nodes using a single property, in accordance with an embodiment of the present disclosure. The hash may be determined by root cause analysis system 100 of FIG. 1 utilizing the hash algorithm as shown. In this example, a hash may be determined for each node of the context graph or subgraph 200 based on selected properties. The properties may include metrics of the node and/or aggregated neighbor related information. The aggregated neighbor related information may include a number of neighbors, an absolute number of neighbors with some conditions, a relative number of neighbors with some condition, a sum/maximum/minimum/average of some node properties, etc. A number of iterations 210, 220 may also be utilized to determine the hashes. The number of iterations may be based on a diameter of the context graph or subgraph, a desired input size, etc. The information associated to a single node for a particular property are the values in its column in the table for each iteration 210, 220.

For example, using a number of neighbors as the selected property, at iteration 0, the hash of node A is represented by H(1) because its only neighbor is node B. Under the same properties, the hash of nodes B, C, D, E are represented by H(3), H(2), H(1), and H(1) because nodes B, C, D, E have 3, 2, 1, 1 neighbors, respectively. In some embodiments, direction of the edges is ignored. In other embodiments, direction of the edges is utilized as a property.

In the same example, and still referring to FIG. 2, at iteration 1, the hash of node A considers a hash of (the hash of node A and the hash of node B) which can be represented by H(H(1)H(3)). Under the same properties, the hash of nodes B, C, D, E are represented by H(H(3)H(1)H(1)H(2)), H(H(2)H(1)H(3)), H(H(1)H(2)), and H(H(1)H(2)). As can be appreciated, this circular hashing process can be utilized for multiple iterations or depths of the context graph to provide a fingerprint or identifying characteristics of the context graph corresponding to the selected properties of nodes of the context graph which can be utilized to identify similar subgraphs or context graphs.

Turning now to FIG. 3, an exemplary hash algorithm for context graph nodes is illustrated using multiple properties, in accordance with an embodiment of the present disclosure. The hash may be determined by root cause analysis system 100 of FIG. 1 utilizing the hash algorithm as shown. For example, using a number of neighbors as the selected property, at iteration 0, the hash of node A is represented by H(1) 310 because its only neighbor is node B. At iteration 1, the hash of node A considers a hash of (the hash of node A and the hash of node B) which can be represented by H(H(1)H(3)) 312. Similarly, using CPU as the selected property, at iteration 0, the hash of node A is represented by H(40%) 320. At iteration 1, the hash of node A considers a hash of (the hash of node A and the hash of node B) which can be represented by H(H(40)H(60)) 322.

Referring back to FIG. 1, encoding t 124 through encoding t+W 134 are provided to CNN 140 along with labels corresponding to root causes. CNN 140 may include multiple layers, such as an input layer that the training data is fed into, hidden layers, and an output layer. The CNN 140 is trained, in some embodiments, with an iterative training method. For example, batch or stochastic gradient descent may be utilized to train the CNN 140.

Once the CNN 140 is trained, test data may be received by the root cause analysis system 100. The test data may be received, in various embodiments, from monitoring tool 112, anomaly detector 114, and/or database 116. The test data comprises metrics 117 and anomalies 118. Each instance of test data also corresponds to a state that may be represented by a timestamp indicating when the metrics and/or anomalies occurred within a particular component of datacenter 110. Root cause analysis system 100 receives test data for multiple states, as illustrated in FIG. 1 by state A 120 and state B 130 (also utilized to illustrate training data as described above). Receiving multiple states enables the root cause analysis system 100 to consider data as it evolves over time and more accurately predict root causes.

After receiving the test data from database 116 corresponding to multiple states, the data is utilized to build a context graph or subgraph. As described above, a context graph refers to a data structure that depicts connections or relationships between components of the datacenter. The context graph consists of nodes (vertices, points) and edges (arcs, lines) that connect them. Each node represents a component and each edge represents a relationship between the corresponding components. The nodes and edges may be labeled or enriched with the metrics, anomalies, and/or root causes. In some embodiments, the test data is received as a context graph or subgraph that has already been built prior to being received by root cause analysis system 100.

As illustrated, the test data for each state, as illustrated by state A 120 through state B 130 (also utilized to illustrate training data as described above), is embedded into a context graph or subgraph, as illustrated by graph embedding 122 through graph embedding 132. The context graphs or subgraphs are utilized to determine an encoding (as illustrated by encoding t 124 through encoding t+W 134). The encoding is a sequence of datacenter states represented by a plurality of hashes. The hashes are based on selected properties of the node and selected properties of neighbors of the node. The hashes may be determined by using, for example, the hash algorithms described with respect to FIGS. 2 and 3.

The hashes are provided to CNN 140 which labels a root cause for the anomalous condition that was detected in the datacenter at the particular state corresponding to the hash. In some embodiments, the root cause may include false positives, artifacts, and incidentals that account for normal operation, despite having anomalies.

In some embodiments, it is possible to obtain which types of configurations are associated to a particular label, thus creating “graph stereotypes” associated to particular problems. This information is valuable to provide human-understandable diagnosis explanations and can be used to feed a rule-based or graph-rule-based diagnostic system (i.e., a system that works with rules, but in which rules are specified using graph properties, such as reachability, centrality, etc.).

In some embodiments, CNN 140 may receive as an input a particular label or root cause. Sequences of hashes that correspond to the particular label are provided as output. This enables the training data to be scanned to identify which structures (e.g., context graphs or subgraphs) correspond to those hashes so that a particular problem may be diagnosed.

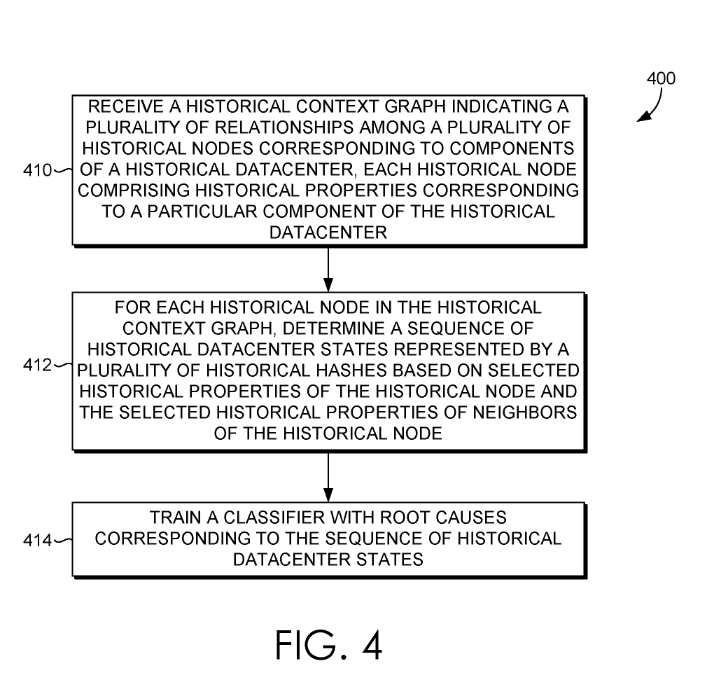

Turning now to FIG. 4, a flow diagram is provided that illustrates a method 400 for training a classifier with a root cause corresponding to a sequence of historical datacenter states, in accordance with embodiments of the present disclosure. For instance, the method 400 may be employed utilizing the root cause analysis system 100 of FIG. 1. As shown at step 410, a historical context graph is received. In some embodiments, historical properties are initially received from a historical database to build the historical context graph. The historical context graph indicates a plurality of relationships among a plurality of historical nodes corresponding to components of a historical datacenter. Each historical node comprises historical properties corresponding to a particular historical component of the historical datacenter. In embodiments, the historical properties include metrics, anomalies, and root causes.

For each historical node in the historical context graph, a sequence of historical datacenter states is determined at step 412. The sequence of historical datacenter states is represented by a plurality of historical hashes based on selected historical properties of the historical node and the selected historical properties of neighbors of the historical node. A maximum number of neighbors of the historical node may be utilized to determine the sequences of historical hashes. In embodiments, the plurality of historical hashes is based on selected properties of the historical node and a number of neighbors of the historical node having the same condition. Additionally or alternatively, the plurality of historical hashes is based on selected properties of the node and a percentage of neighbors of the node having the same condition.

A classifier is trained, at step 414, with root causes corresponding to the sequences of historical datacenter states. The classifier may be trained with an iterative training method. In embodiments, the classifier is utilized to label a root cause for a particular anomalous condition detected in a datacenter. The root cause, the particular anomalous condition, and corresponding properties may be provided to a historical database to use as additional training data. The internal state of the CNN may be shared with other organizations implementing a root cause analysis system. In this way, the root cause analysis system may be provided as a software as a service model that utilizes the internal state of the CNN for multiple organizations that has been trained with inputs comprising historical properties received from a plurality of historical datacenters. In some embodiments, the CNN is trained using historical properties received from only historical datacenter(s) corresponding to a single organization.

In some embodiments, a selection of a particular label (e.g., a root cause) is received. The CNN may determine a sequence of hashes corresponding to the particular label. A list of subgraphs corresponding to the sequence of hashes can be provided and utilized to diagnose a particular problem in the datacenter.

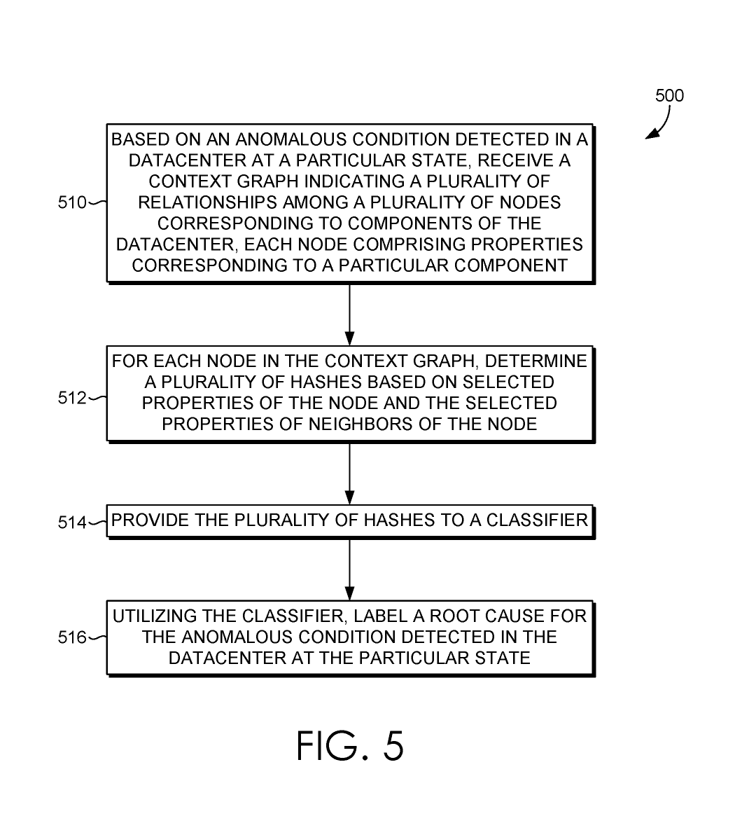

In some embodiments, and referring now to FIG. 5, a flow diagram is provided that illustrates a method 500 for utilizing a classifier to label an anomalous condition detected in a datacenter at a particular state, in accordance with embodiments of the present disclosure. For instance, the method 500 may be employed utilizing the root cause analysis system 100 of FIG. 1. As shown at step 510, based on an anomalous condition detected in a datacenter at a particular state, a context graph is received. The context graph indicates a plurality of relationships among a plurality of nodes corresponding to components of the datacenter. Each node comprising properties corresponding to a particular component.

At step 512, for each node in the context graph, a plurality of hashes is determined based on selected properties of the node and the selected properties of neighbors of the node. The plurality of hashes is provided to a classifier, at step 514. Utilizing the classifier, the anomalous condition detected in the datacenter at the particular state is labeled, at step 516, with a root cause. In some embodiments, the root causes include false positives, artifacts, and incidentals that account for normal operation, despite having anomalies.

In some embodiments, historical properties are received from a historical database and may be utilized as training data to train the classifier. The historical properties correspond to historical nodes in the historical datacenter. For example, utilizing the historical properties, sequences of historical datacenter states represented by historical hashes may be determined based on selected historical properties of the historical node and the selected historical properties of neighbors of the historical node.

Having described embodiments of the present disclosure, an exemplary operating environment in which embodiments of the present disclosure may be implemented is described below in order to provide a general context for various aspects of the present disclosure. Referring to FIG. 6 in particular, an exemplary operating environment for implementing embodiments of the present disclosure is shown and designated generally as computing device 600. Computing device 600 is but one example of a suitable computing environment and is not intended to suggest any limitation as to the scope of use or functionality of the inventive embodiments. Neither should the computing device 600 be interpreted as having any dependency or requirement relating to any one or combination of components illustrated.

The inventive embodiments may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The inventive embodiments may be practiced in a variety of system configurations, including handheld devices, consumer electronics, general-purpose computers, more specialty computing devices, etc. The inventive embodiments may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output (I/O) ports 618, input/output (I/O) components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 6 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 612 includes computer-storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

As can be understood, embodiments of the present disclosure provide for an objective approach for providing a root cause analysis system that predicts root causes of anomalies in a datacenter. The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method comprising:
receiving a historical context graph indicating a plurality of relationships among a plurality of historical nodes corresponding to components of a historical datacenter, each historical node comprising historical properties corresponding to a particular historical component of the historical datacenter;
for each historical node in the historical context graph, determining a sequence of historical datacenter states represented by a plurality of historical hashes based on selected historical properties of the historical node and the selected historical properties of neighbors of the historical node; and
training a classifier with root causes corresponding to the sequences of historical datacenter states.

2. The method of claim 1, wherein the historical properties include metrics, anomalies, and root causes.

3. The media of claim 1, further comprising utilizing the classifier, labeling a root cause for a particular anomalous condition detected in a datacenter.

4. The method of claim 3, further comprising providing the root cause, the particular anomalous condition, and corresponding properties to a historical database.

5. The method of claim 1, receiving historical properties from a historical database to build the historical context graph.

6. The method of claim 1, wherein the classifier is trained with an iterative training method.

7. The method of claim 1, wherein a maximum number of neighbors of the historical node is utilized to determine the sequences of historical hashes.

8. The method of claim 1, wherein the plurality of historical hashes is based on selected properties of the historical node and a number of neighbors of the historical node having the same condition.

9. The method of claim 1, wherein the plurality of historical hashes is based on selected properties of the node and a percentage of neighbors of the node having the same condition.

10. The method of claim 1, wherein a software as a service model is utilized to train the classifier utilizing historical properties received from a plurality of historical datacenters.

11. The method of claim 1, receiving a selection of a particular label.

12. The method of claim 11, further comprising determining a sequence of hashes corresponding to the particular label.

13. The method of claim 12, further comprising providing a list of subgraphs corresponding to the sequence of hashes.

14. The method of claim 13, further comprising utilizing the list of subgraphs to diagnose a particular problem in the datacenter.

15. A method comprising:
based on an anomalous condition detected in a datacenter at a particular state, receiving a context graph indicating a plurality of relationships among a plurality of nodes corresponding to components of the datacenter, each node comprising properties corresponding to a particular component;
for each node in the context graph, determining a plurality of hashes based on selected properties of the node and the selected properties of neighbors of the node;
providing the plurality of hashes to a classifier; and
utilizing the classifier, labeling a root cause for the anomalous condition detected in the datacenter at the particular state.

16. The method of claim 15, further comprising receiving historical properties from a historical database, the historical properties corresponding to historical nodes in the historical datacenter.

17. The method of claim 16, utilizing the historical properties, determining sequences of historical datacenter states represented by historical hashes, based on selected historical properties of the historical node and the selected historical properties of neighbors of the historical node.

18. The method of claim 17, further comprising utilizing the historical hashes, training a classifier with root causes corresponding to the selected historical properties.

19. The method of claim 15, wherein the root causes includes false positives, artifacts, and incidentals that account for normal operation, despite having anomalies.

20. A computerized system:
a processor; and
a non-transitory computer storage medium storing computer-useable instructions that, when used by the processor, cause the processor to:
receive a historical context graph indicating a plurality of relationships among a plurality of historical nodes corresponding to components of a historical datacenter, each historical node comprising historical properties corresponding to a particular historical component;
for each historical node in the historical context graph, determine a sequence of datacenter states represented by a plurality of historical hashes based on selected historical properties of the historical node and the selected historical properties of neighbors of the historical node; and
training a classifier with root causes corresponding to the sequence of datacenter states; and
utilizing the classifier, label a root cause for a particular anomalous condition detected in a datacenter at a particular state.
